(19) United States
(12) Patent Application Publication
(10) Pub. No.: US 2010/0150447 A1
(43) Pub. Date: Jun. 17, 2010

(54) DESCRIPTION BASED VIDEO SEARCHING SYSTEM AND METHOD

(75) Inventors: Ganesh GunasekaranBabu, Coimbatore (IN); Abdul Raheem, Madurai (IN); Balaji Sivakumar, K. K. Nagar (IN); Prabhu S., Siva Hanhai (IN); Gopalakrishnan Venkatesan, Madurai (IN)

Correspondence Address: HONEYWELL/HUSCH;Patent Services, 101 Columbia Road, P.O.Box 2245, Morrlstown, NJ, 07962, US

(73) Assignee: Honeywell International Inc., Morristown, NJ (US)

(21) Appl. No.: 12/333,849

(22) Filed: Dec. 12, 2008

(51) Int. Cl. G06K 9/46; H04N 5/91

(52) U.S. Cl. 382/190; 386/69

(57) ABSTRACT

A method of and system for searching a video information is provided. The method includes inputting video information, acquiring a first frame of the video information, searching the first frame for a desired object, searching the first frame for a desired feature if the desired object is found in the first frame, and marking the first frame if the desired feature is found in the first frame. The method further includes acquiring, searching, and marking subsequent frames of the video information as necessary until the end of the video is reached.

### FIELD OF INVENTION

The present invention relates generally to video searching. More particularly, the present invention relates to systems and methods of identifying and locating objects in real-time or pre-stored video data streams or information based on descriptions of the objects or features.

### BACKGROUND

Intelligent security has become a widespread and necessary reality of modern day civilization, and one aspect of known intelligent security is video surveillance. Video surveillance is being increasingly used and accordingly, the amount of available digital video information has become enormous. As the availability of digital video information increases, the need to search the digital video and locate frames or sequences having desired information also increases.

Traditionally, a search of digital video for information has been a manual process. For example, in a police investigation, huge databases of video information must be processed manually to identify clues or information. This is a time consuming and tedious process. Thus, the time, expense, and man hours associated with manually searching digital video has led many users to desire a system and method for automatically carrying out description or content based video searches in which specific pieces of video information can be searched for and retrieved.

Accordingly, there is a continuing, ongoing need for a system and method for description or content based video searching. Preferably, when a description of a person or object is provided in such systems and methods, an object based search method can be employed to locate and provide a video clip of the desired person, object, or feature.

### BRIEF DESCRIPTION OF THE DRAWINGS

FIG. 1 is a flow diagram of a method of identifying an object in a video in accordance with the present invention;

FIG. 2 is a flow diagram of a method of detecting a beard in a static image in accordance with the present invention;

FIG. 3 is a flow diagram of a method of detecting a mustache in a static image in accordance with the present invention;

FIG. 4 is a flow diagram of a method of detecting spectacles in a static image in accordance with the present invention;

FIG. 5 is an interactive window displayed on a viewing screen of a graphical user interface for searching for an object in a video; and

FIG. 6 is a block diagram of a system for carrying out the methods of FIGS. 1-4.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include an automatic method of identifying and locating an object or feature in real-time or pre-stored video. In such a method, a digital video data file to be searched and a description of an object or feature can be provided as input. For example, the description of an object to be searched for can be a person with a mustache, a person with a beard, a person wearing spectacles, or the like all without limitation.

In accordance with the method, the video can be analyzed, and a search for the described object can be performed. After the search is complete or while the search continues to run, a thumbnail of every occurrence of the described object on the video can be provided or presented to a user.

It is to be understood that the description of the object or feature to be searched is not a limitation of the present invention. However, every object or feature that can be described or selected is appropriately searched to best identify the object. Each object or feature identification or selection can be searched via a specific method. For example, if the described object is a person with a mustache, a beard, or wearing spectacles, an identification process must first search for persons with a face. After a human face is detected, then specific processes for beard detection, mustache detection, or spectacle detection, for example, can be employed.

In accordance with the present invention, no additional manual effort is necessary because searching and locating an object or feature is performed automatically. Additionally, because the present invention employs a description or object based video search method, indices or databases of objects are not necessary.

Methods and systems in accordance with the present invention can be used in a variety of settings. For example, a method and system in accordance with the present invention can be used in a crime scene investigation to search for an object in stored digital video. Furthermore, methods and systems in accordance with the present invention can be used in video surveillance to track objects.

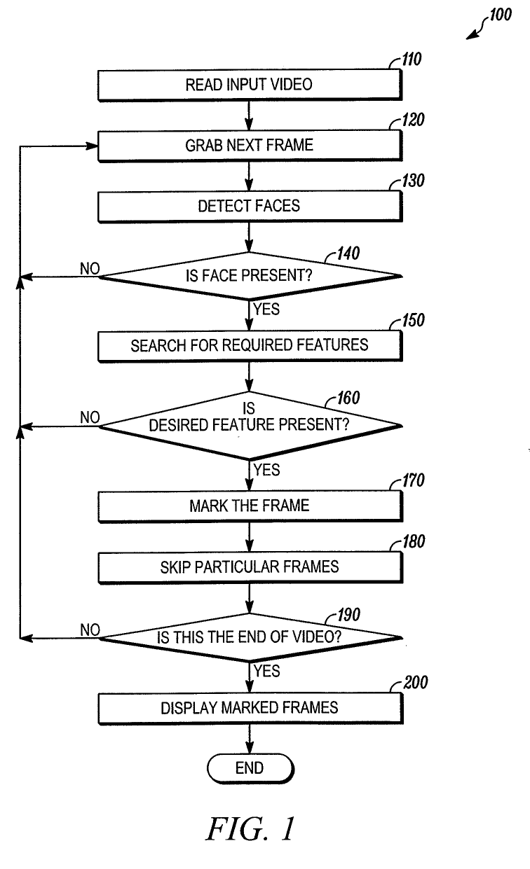

Referring now to FIG. 1, a flow chart of an exemplary method 100 of identifying an object in a video in accordance with the present invention is shown. It is to be understood that the methods shown in FIGS. 1-4 are merely exemplary. Various methods of searching for various objects can be employed and come within the spirit and scope of the present invention. Those of skill in the art will understand that the principles illustrated in FIGS. 1-4 can be incorporated into searches for any number of objects.

The exemplary method 100 shown in FIG. 1 can be executed if a description of an object is provided such that the desired object or feature to be located would appear on a person's face. In the method 100, input video can be loaded and read as in 110. The first and then each subsequent frame can be acquired or grabbed as in 120, and the remainder of the method 100 can be performed on each frame.

Each frame can be searched for faces as in 130, and the method 100 can determine whether a face is present as in 140. If a face is not present, the method 100 can proceed to grab the next frame of the video to be searched as in 120. However, if a face is present, the method 100 can proceed to search the current frame for the desired feature or features as in 150.

The method 100 can determine whether the desired feature or features are present as in 160 and if so, the current frame can be marked as in 170. If the desired feature or features are not present, then the method 100 can proceed to grab the next frame of the video to be searched as in 120.

If a particular frame is marked as in 170, the method 100 can skip particular frames as in 180 and then determine if the current frame is the end of the video as in 190. If the current frame is not the end of the video, then the method 100 can proceed to grab the next frame of the video to be searched as in 120. However, if the current frame is the end of the video, the method can display any marked frames as in 200.

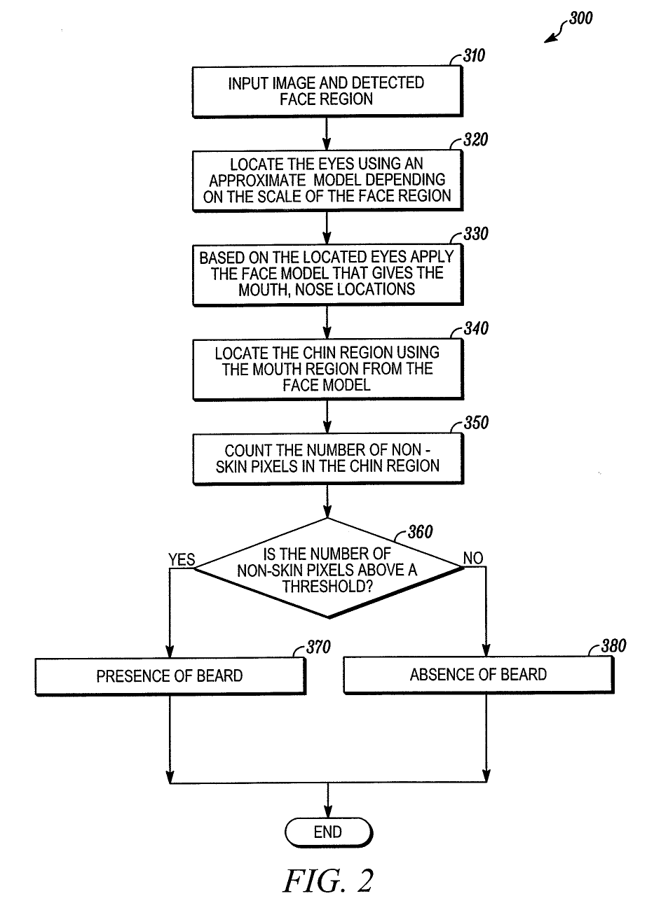

FIGS. 2-4 illustrate flow charts of exemplary methods that can implement desired searches, as in 150, if the desired feature is a beard, mustache, or spectacles, for example.

Referring now to FIG. 2, a flow chart of a method 300 of detecting a beard in a static image in accordance with the present invention is shown. Initially, an image and a detected face region can be input as in 310. Then, the eyes of the face region can be located as in 320 using an approximate model depending on the scale of the face region.

Based on the location of the eyes on the face region, a face model can be applied as in 330 that can give the mouth and nose locations. Then, a chin region can be located as in 340 using the mouth region from the face model.

The method 300 can count the number of non-skin pixels in the chin region as in 350 and determine if the number of non-skin pixels is above a predetermined threshold as in 360. If the number of non-skin pixels is above the threshold, then the method 300 can determine that a beard is present as in 370. However, if the number of non-skin pixels is not above the threshold, then the method 300 can determine that a beard is not present as in 380.

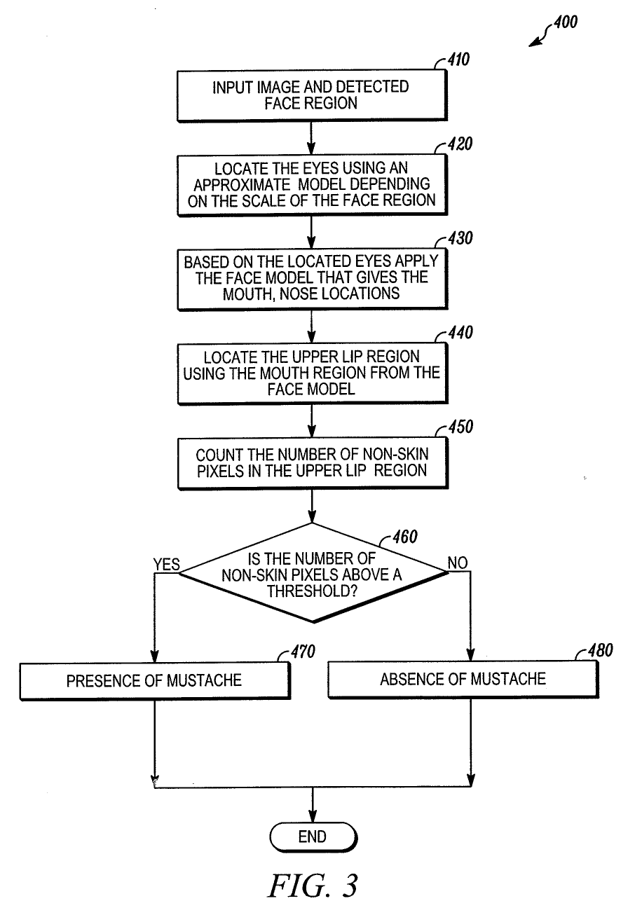

FIG. 3 illustrates a flow chart of a method 400 of detecting a mustache in a static image in accordance with the present invention. Initially, an image and a detected face region can be input as in 410. Then, the eyes of the face region can be located as in 420 using an approximate model depending on the scale of the face region.

Based on the location of the eyes on the face region, a face model can be applied as in 430 that can give the mouth and nose locations. Then, an upper lip region can be located as in 440 using the mouth region from the face model.

The method 400 can count the number of non-skin pixels in the upper lip region as in 450 and determine if the number of non-skin pixels is above a predetermined threshold as in 460. If the number of non-skin pixels is above the threshold, then the method 400 can determine that a mustache is present as in 470. However, if the number of non-skin pixels is not above the threshold, then the method 400 can determine that a beard is not present as in 480.

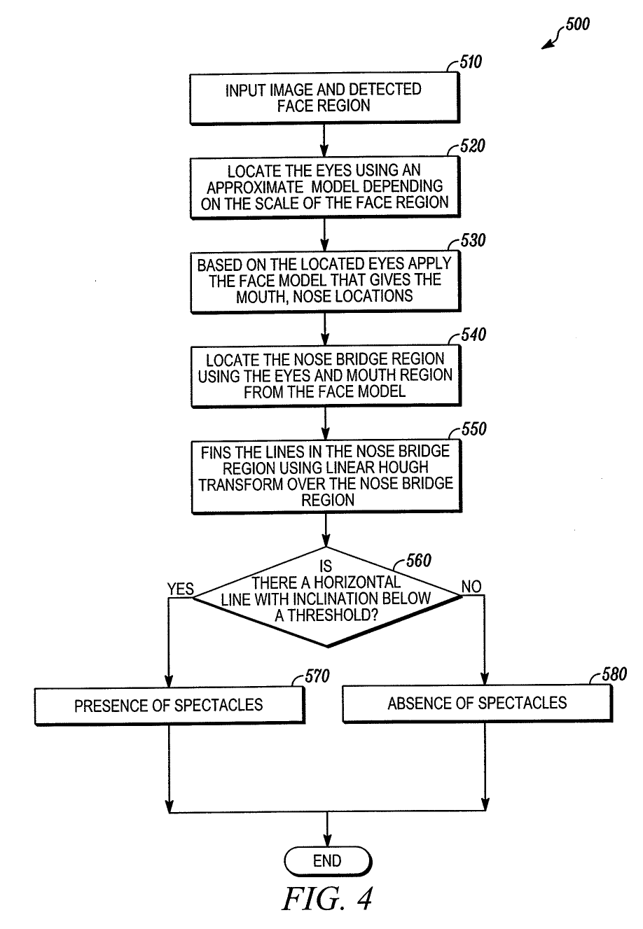

FIG. 4 illustrates a flow chart of a method 500 of detecting spectacles in a static image in accordance with the present invention. Initially, an image and a detected face region can be input as in 510. Then, the eyes of the face region can be located as in 520 using an approximate model depending on the scale of the face region.

Based on the location of the eyes on the face region, a face model can be applied as in 530 that can give the mouth and nose locations. Then, a nose bridge region can be located as in 540 using the eyes and mouth region from the face model.

The method 500 can find lines in the nose bridge region using a linear Hough Transform over the nose bridge region as in 550 and determine whether there is a horizontal line with inclination below a predetermined threshold as in 560. If there is a line below the threshold, then the method 500 can determine that spectacles are present as in 570. However, if there is not a line below the threshold, then the method 500 can determine that spectacles are not present as in 580.

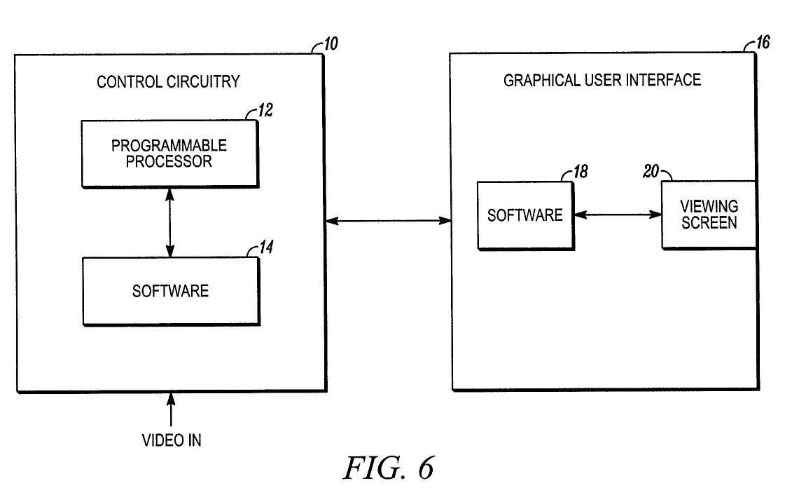

The methods shown in FIGS. 1-4 and others in accordance with the present invention can be implemented with a programmable processor and associated control circuitry. As seen in FIG. 6, control circuitry 10 can include a programmable processor 12 and associated software 14 as would be understood by those of ordinary skill in the art. Real-time or pre-stored video data streams or information can be input into the programmable processor 12 and associated control circuitry 10. An associated graphical user interface 16 can be in communication with the processor 12 and associated circuitry 10, and a viewing screen 20 of the graphical user interface 16 as would be known by those of ordinary skill in the art can display an interactive window.

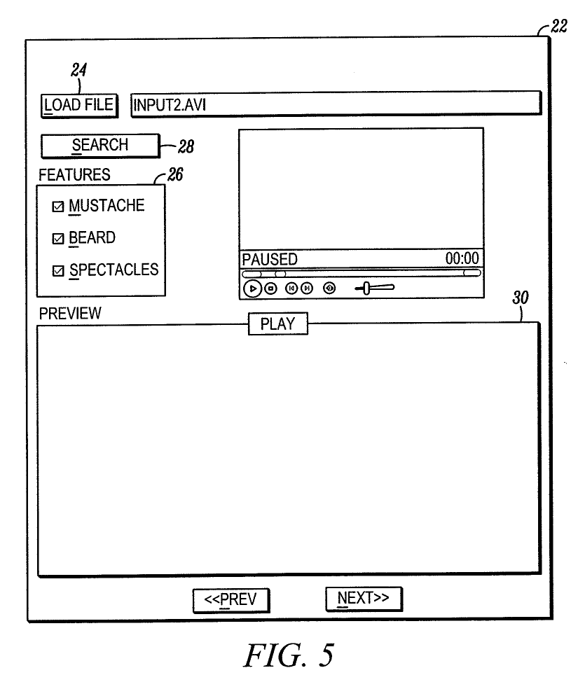

FIG. 5 is a block diagram of an exemplary interactive window 22 displayed on the viewing screen 20 of a graphical user interface 18 for searching for an object in a video. Those of skill in the art will understand that the features of the interactive in window 22 in FIG. 5 may be displayed by additional or alternate windows. Alternatively, the features of the interactive window 22 of FIG. 5 can be displayed on a console interface without graphics.

Using the exemplary interactive window 22 of FIG. 5, a user can cause a video file to be loaded by clicking or pressing a Load File button 24. The user can also determine which objects or features should be searched for in the loaded video, for example, by selecting the desired object or feature from a list of choices 26. Finally, the user can cause the loaded video to be automatically searched for the selected objects or features by clicking or pressing the Search button 28. When, the Search button is employed, methods in accordance with the present invention and as described above can be implemented by the associated processor 12, control software 14, and control circuitry 10. The results of the methods can be displayed on the interactive window 22 of FIG. 5, for example, in the Preview pane 30.

Software 14, which can implement the exemplary methods of FIGS. 1-4, can be stored on a computer readable medium, for example, a disk or solid state memory, and be executed by processor 12. The disk and associated software can be removably coupled to processor 12. Alternatively, the software 14 can be downloaded to the medium via a computer network.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. A method of searching video information comprising:
inputting video information;
acquiring a first frame of the video information;
searching the first frame for a desired object;
searching the first frame for a desired feature if the desired object is found in the first frame; and
marking the first frame if the desired feature is found in the first frame.

2. The method of claim 1 wherein the desired object is a human face

3. The method of claim 1 wherein the desired feature is at least one of a mustache, beard, or spectacles.

4. The method of claim 1 further comprising acquiring a second frame of the video information.

5. The method of claim 1 further comprising providing a thumbnail of the first frame if the first frame is marked.

6. The method of claim 1 wherein searching the first frame for the desired feature further comprises:
locating a first feature of the desired object;
determining a location of a second feature and a location of a third feature based on the location of the first feature;
locating a desired region based on at least one of the first feature, the second feature, or the third feature; and
determining a presence or absence of the desired feature in the desired region.

7. The method of claim 6 wherein the first feature, the second feature, and the third feature are any one of eyes, nose, or mouth.

8. The method of claim 6 wherein the desired region is any one of a chin region, an upper lip region, or a nose bridge region.

9. The method of claim 6 wherein determining the presence or absence of the desired feature in the desired region further comprises counting pixels in the desired region.

10. An interactive viewing apparatus comprising:
means for loading video information;
means for selecting a desired object or desired feature; and
means for initiating an automatic search of the video for the desired object or the desired feature.

11. The interactive viewing apparatus of claim 10 further comprising means for displaying results of the search of the video for the desired object or the desired feature.

12. The interactive viewing apparatus of claim 10 which includes a graphical user interface associated with at least one of control circuitry or a programmable processor.

13. The interactive viewing apparatus of claim 12 wherein the control circuitry or the programmable processor executes the automatic search of the video for the desired object or the desired feature.

14. A system for searching video images for a desired object comprising:
a programmable processor and associated control circuitry; and
a user interface, wherein the programmable processor and the associated control circuitry acquire a first frame of the video, search the first frame for the desired object, search the first frame for a desired feature if the desired object is found in the first frame, and mark the first frame if the desired feature is found in the first frame.

15. The system of claim 14 wherein the programmable processor and the associated control circuitry acquire a second frame of the video.

16. The system of claim 14 wherein the user interface displays a thumbnail of the first frame if the first frame is marked.

17. The system of claim 14 wherein the programmable processor and the associated control circuitry locate a first feature of the desired object if the desired object is found in the first frame, determine a location of a second feature and a location of a third feature based on the location of the first feature, locate a desired region based on at least one of the first feature, the second feature, or the third feature, and determine a presence or absence of the desired feature in the desired region.

18. The system of claim 17 wherein the programmable processor and the associated control circuitry count pixels in the desired region to determine a presence or absence of the desired feature in the desired region.

19. The system of claim 14 wherein the desired object is a human face.

20. The system of claim 14 wherein the desired feature is at least one of a mustache, beard, or spectacles.
